(19) United States
(12) Patent Application Publication
(10) Pub. No.: US 2022/0163658 A1
(43) Pub. Date: May 26, 2022

(54) SYSTEM AND METHOD

(71) Applicant: KABUSHIKI KAISHA TOSHIBA, Tokyo (JP)

(72) Inventors: Kentaro YOSHIOKA, Kawasaki (JP); Kazuhiro TSUJIMURA, Tokyo (JP); Hiroki MORI, Kawasaki (JP)

(73) Assignee: KABUSHIKI KAISHA TOSHIBA, Tokyo (JP)

(21) Appl. No.: 17/469,445

(22) Filed: Sep. 8, 2021

(30) Foreign Application Priority Data
Nov. 26, 2020 (JP) 2020-195949

(51) Int. Cl. G01S 13/88; G01S 13/68; G01S 13/56; G01S 13/89; G01S 13/28; G01S 13/86; G01S 7/41

(52) U.S. Cl. CPC G01S 13/887; G01S 13/68; G01S 13/56; G01S 7/411; G01S 13/282; G01S 13/867; G01S 13/886; G01S 13/89

(57) ABSTRACT

According to one embodiment, a system includes a radar device, a storage device and a controller. The radar device is configured to transmit a first radio wave to an object in a direction of a first angle of the object. The storage device is configured to store first information capable of specifying that a radio wave is transmitted to the first angle of the object by the radar device. The controller is configured to control a direction of a second radio wave to be transmitted by the radar device after the transmission of the first radio wave to a second angle of the object different from the first angle.

### CROSS-REFERENCE TO RELATED APPLICATIONS

This application is based upon and claims the benefit of priority from Japanese Patent Application No. 2020-195949, filed Nov. 26, 2020, the entire contents of which are incorporated herein by reference.

### FIELD

Embodiments described herein relate generally to a system and a method.

### BACKGROUND

In recent years, for example, a system that performs security inspection using radio waves such as millimeter waves has been developed. However, in such a system, a radio wave recovery rate, from an object other than an object having a reflection surface on a front surface, of a radar device capable of transmitting radio waves is low, and for example, it is difficult to detect an object having the reflection surface inclined with respect to the radar device, so that miss detection occurs.

Therefore, regarding a system which detects an object by using radio waves, it is desired to realize a system capable of suppressing the above-described miss detection.

### BRIEF DESCRIPTION OF THE DRAWINGS

FIG. 1 is a diagram for explaining a usage mode of a system according to a first embodiment.

FIG. 2 is a block diagram illustrating an example of a functional configuration of a system according to the embodiment.

FIG. 3 is a schematic diagram illustrating an example of result data stored in a sensing result database according to the embodiment.

FIG. 4 is a block diagram illustrating an example of a hardware configuration of a radar device according to the embodiment.

FIG. 5 is a schematic diagram for explaining a detection principle of the radar device according to the embodiment.

FIG. 6 is a flowchart illustrating an example of a procedure of a sensing process executed by the system according to the embodiment.

FIG. 7 is a schematic diagram for explaining a state transition of the sensing result database according to the embodiment.

FIG. 8 is a schematic diagram for explaining the state transition of the sensing result database according to the embodiment.

FIG. 9 is a block diagram illustrating an example of a functional configuration of a system according to a second embodiment.

FIG. 10 is a schematic diagram for explaining a reflection plate and an adjustment mechanism according to the embodiment.

FIG. 11 is a schematic diagram illustrating a modification of the system according to the embodiment.

FIG. 12 is a block diagram illustrating an example of a functional configuration of a system according to a third embodiment.

FIG. 13 is a schematic diagram for explaining a plurality of radar devices according to the embodiment.

### DETAILED DESCRIPTION

In general, according to one embodiment, a system comprises a radar device, a storage device and a controller. The radar device is configured to transmit a first radio wave to an object in a direction of a first angle of the object. The storage device is configured to store first information capable of specifying that a radio wave is transmitted to the first angle of the object by the radar device. The controller is configured to control a direction of a second radio wave to be transmitted by the radar device after the transmission of the first radio wave to a second angle of the object different from the first angle.

Some embodiments will be described with reference to the drawings.

It should be noted that the disclosure is merely an example, and a person skilled in the art can appropriately change the present invention without departing from the scope of the present invention, and it is naturally included in the scope of the present invention. Further, in order to make the description clearer, the drawings may schematically be illustrated as compared with the actual mode. However, this is merely an example, and the interpretation of the present invention is not limited. Further, in this specification and each drawing, components that exhibit the same or similar functions as those described above with respect to the previously described drawings are denoted by the same reference numerals, and redundant detailed description may be omitted.

### First Embodiment

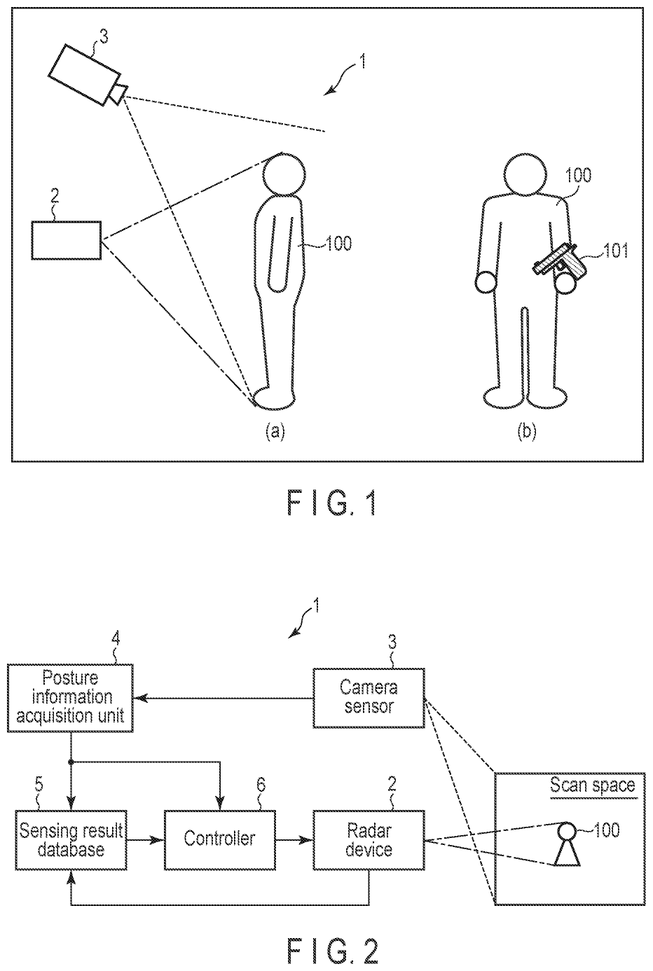

First, a usage mode of a system according to a first embodiment will be described with reference to FIG. 1. As illustrated in FIG. 1(a), a system 1 according to this embodiment includes a radar device 2 and a camera sensor 3, and is used as a sensing system for performing a security inspection on a person (pedestrian) 100 present in a scan space. The system 1 is used in, for example, public facilities such as airports and stations, but may be used in other places. Incidentally, FIG. 1(a) illustrates a configuration in which the system 1 includes one radar device 2 and one camera sensor 3, but the number of radar devices 2 and the number of camera sensors 3 are not limited thereto, and may be one or more.

In this embodiment, an example of the radio wave transmitted from the radar device 2 is a millimeter wave (EHF: Extra High Frequency), and the millimeter wave has characteristics of having strong directivity and exhibiting strong reflection when colliding a metal substance, while being absorbed by a human body and easily transmitting a non-metal substance such as clothes. Therefore, by using the radar device 2 for a person 100 present in the scan space, it is possible to inspect an object (a metal dangerous article (such as gun and a knife) hidden under baggage or clothes) possessed by the person 100 without damaging the human body. FIG. 1(b) illustrates a case where the person 100 has a gun 101 hidden in the left inner pocket of a jacket, and the gun is detected by the radar device 2.

In this embodiment, the person 100 is assumed as a measurement target (inspection target, object), but the measurement target is not limited thereto. For example, a box-shaped housing, baggage (bag), or the like placed in the scan space may be the measurement target. In this case, the system 1 is used to inspect an object held inside the box-shaped housing or the baggage.

As described above, the system 1 according to this embodiment includes the camera sensor 3 in addition to the radar device 2. The camera sensor 3 is provided to enable the radar device 2 to transmit millimeter waves for various angles of the person 100 present in the scan space.

The millimeter wave transmitted from the radar device 2 exhibits strong reflection when colliding with a metal substance having a reflection surface perpendicular to the arrival direction of the millimeter wave, but does not exhibit strong reflection when colliding with a metal substance having a reflection surface inclined with respect to the arrival direction of the millimeter wave. Therefore, there is an inconvenience that it is difficult to detect a metal substance having a reflection surface inclined with respect to the arrival direction of the millimeter wave. The camera sensor 3 is provided to eliminate such inconvenience, and as described above, enables the radar device 2 to transmit millimeter waves to various angles (of reflection surfaces) of the metal substance. According to this, it is possible to suppress miss detection of the metal substance.

Incidentally, the radar device 2 according to this embodiment is installed, for example, at the tip of a robot arm capable of moving around the measurement target person 100. According to this, by moving the robot arm on which the radar device 2 is installed around the measurement target person 100, the radar device 2 can transmit millimeter waves to various angles of the person 100.

Alternatively, in order to enable the radar device 2 to transmit millimeter waves at various angles of the measurement target person 100, the radar device 2 may be installed, for example, in a bent passage (zigzag-curved passage). According to this, since the measurement target person 100 walks while changing a direction, it is possible to transmit millimeter waves to various angles of the person 100 as a result without moving the radar device 2.

The above-described camera sensor 3 acquires (captures) an image of the person 100 present in the scan space. Although details will be described later, the image of the person 100 acquired by the camera sensor 3 is used to acquire (estimate) posture information of the person 100.

Incidentally, the camera sensor 3 may be of any type as long as it can acquire at least a two-dimensional image. However, as the image quality of the image acquired by the camera sensor 3 is higher, the estimation accuracy of the posture information of the person 100 to be described later can be improved.

The system 1 according to this embodiment may further include a distance sensor capable of acquiring a distance to the person 100 present in the scan space in addition to the camera sensor 3. Alternatively, the system 1 according to this embodiment may include a LiDAR instead of the camera sensor 3. According to this, the image of the person 100 present in the scan space and the distance to the person 100 can be simultaneously acquired, and the three-dimensional coordinates of the person 100 can also be acquired, so that the estimation accuracy of the posture information of the person 100 to be described later can be improved.

FIG. 2 is a block diagram illustrating an example of a functional configuration of the system 1 according to this embodiment. As illustrated in FIG. 2, the system 1 further includes a posture information acquisition unit 4, a sensing result database 5, and a controller 6 in addition to the radar device 2 and the camera sensor 3 illustrated in FIG. 1. The posture information acquisition unit 4, the sensing result database 5, and the controller 6 may be implemented as separate devices, or may be implemented as one server device including the posture information acquisition unit 4, the sensing result database 5, and the controller 6. Incidentally, each of the devices 2 to 6 included in the system 1 may include a CPU for controlling the operation of the own device.

The posture information acquisition unit 4 is communicably connected to the camera sensor 3, and acquires (receives) image data indicating an image including the person 100 imaged by the camera sensor 3 from the camera sensor 3.

The posture information acquisition unit 4 acquires (estimation, detection) the posture information of the person 100 based on the acquired image data. Incidentally, the posture information of the person 100 includes, for example, the position of the person 100 and an angle for indicating the direction (the direction of the person 100 facing) in which the person 100 faces. The position of the person 100 in this embodiment may be a position in the scan space or a position as viewed from the radar device 2 or the camera sensor 3. The angle for indicating the direction in which the person 100 faces in this embodiment may be an angle with respect to the radar device 2 or an angle with respect to the camera sensor 3.

Incidentally, the position of the person 100 included in the posture information is estimated by, for example, a method using a machine learning algorithm. Further, the angle, which is included in the posture information, for indicating the direction in which the person 100 faces is estimated based on, for example, the direction of the shoulder or the waist of the person 100. Alternatively, the angle, which is included in the posture information, for indicating the direction in which the person 100 faces is estimated based on the walking direction of the person 100. This estimation method is a method using the fact that the direction in which the person 100 faces coincides with the walking direction of the person 100, and for example, the three-dimensional coordinates of the person 100 are acquired every one second, and the walking direction is detected from the change in the three-dimensional coordinates, thereby estimating the direction in which the person 100 faces.

The posture information acquired by the posture information acquisition unit 4 is sent to the controller 6.

The controller 6 is communicably connected to the radar device 2, and controls the radar device 2 based on the posture information of the person 100 acquired by the posture information acquisition unit 4.

Specifically, the controller 6 lists (detects) sensable angles of the radar device 2 for the person 100 based on the acquired posture information of the person 100 and the device information of the radar device 2. Incidentally, the device information of the radar device 2 includes, for example, the installation position of the radar device 2 and the mobility of the radar device 2. The device information of the radar device 2 is acquired, for example, by communicating with the radar device 2.

The sensable angle is an angle of the measurement target person 100 which can be sensed by the radar device 2 and is an angle which is specified, with a specific direction of the person 100 as a reference, by a difference between the specific direction and a direction in which a millimeter wave is transmitted. In this embodiment, a case is assumed in which angles from the front direction of the person 100 are listed as the sensable angles with reference to the front direction. However, the present invention is not limited thereto, and for example, angles from the direction of the left arm of the person 100 may be listed as the sensable angles with reference to the direction of the left arm. Further, in this embodiment, a case is assumed in which the measurement target is a person. However, for example, in a case where the measurement target is a baggage (bag) or the like, angles from a direction in which a specific design or pattern of the baggage is present may be listed as the sensable angles with reference to the direction.

For example, in a case where the sensable angle is 0 degrees, it is indicated that the radar device 2 can sense the person 100 from the front direction of the measurement target person 100. That is, it is indicated that the radar device 2 can transmit a millimeter wave in the direction of 0 degrees of the measurement target person 100.

In a case where the sensable angle is +θ degrees, it is indicated that the radar device 2 can sense the person 100 from the direction rotated counterclockwise by θ degrees from the front direction of the measurement target person 100. That is, it is indicated that the radar device 2 can transmit a millimeter wave in the direction of +θ degrees of the measurement target person 100.

In a case where the sensable angle is −θ degrees, it is indicated that the radar device 2 can sense the person 100 from the direction rotated clockwise by degrees from the front direction of the measurement target person 100. That is, it is indicated that the radar device 2 can transmit a millimeter wave in the −θ degree direction of the measurement target person 100.

The controller 6 collates the detected sensable angle with the result data stored in the sensing result database 5, and controls the direction of the millimeter wave transmitted by the radar device 2 to the angle of the person 100, toward which the millimeter wave has not yet been transmitted (that is, the radar device 2 is controlled to perform sensing for an angle for which sensing is not performed yet). Incidentally, in a case where the radar device 2 includes a CPU, and the CPU controls the operation of the own device, the controller 6 functions as a transmitter which transmits a signal for controlling the direction of the millimeter wave transmitted by the radar device 2 to the angle of the person 100, toward which the millimeter wave has not yet been transmitted.

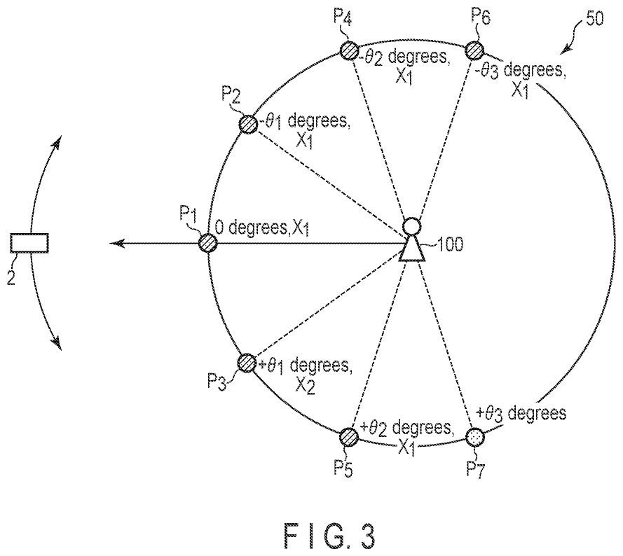

The sensing result database 5 is a storage device which is communicably connected to the radar device 2 and the posture information acquisition unit 4 and stores, for example, the result data 50 illustrated in FIG. 3. The sensing result database 5 includes, for example, a volatile memory.

As illustrated in FIG. 3, for example, the result data 50 includes an angle for which sensing by the radar device 2 is required to suppress miss detection of a metal substance, whether or not sensing for the angle is performed, and a result of the sensing in a case where the sensing is performed.

The angle required to be sensed included in the result data 50 is set in advance before the sensing by the radar device 2 is performed. In FIG. 3, a case is assumed in which seven angles of 0 degrees, ±θ₁ degrees, ±θ₂ degrees, and ±θ₃ degrees are set in advance as angles for which sensing is required. However, the number of angles for which sensing is required and the value thereof are not limited thereto and may be arbitrarily set.

The sensing result included in the result data 50 may indicate the reflection intensity of the millimeter wave received by the radar device 2 or may indicate whether or not a metal substance is detected.

In FIG. 3, points P₁ to P₆ hatched in a mesh shape indicate that sensing by the radar device 2 with respect to the angles corresponding to the points P₁ to P₆ is performed, and a point P₇ hatched in a dot shape indicates that sensing by the radar device 2 with respect to the angle corresponding to the point P₇ is not performed yet.

For example, according to the point P₁ of the result data 50 illustrated in FIG. 3, sensing is performed by the radar device 2 with respect to the front direction of the measurement target person 100 (that is, the radar device 2 transmits a millimeter wave in the direction of 0 degrees of the measurement target person 100), and as a result of the sensing, it is indicated that the reflection intensity of the millimeter wave received by the radar device 2 is X₁ (for example, no metal substance is detected).

According to the point P₂ of the result data 50 illustrated in FIG. 3, sensing is performed by the radar device 2 in the direction rotated clockwise by θ₁ degrees (−θ₁ degrees) from the front direction of the measurement target person 100 (that is, the radar device 2 transmits a millimeter wave in the direction of −θ₁ degrees of the measurement target person 100), and as a result of the sensing, it is indicated that the reflection intensity of the millimeter wave recovered by the radar device 2 is X₁ (for example, no metal substance is detected).

According to the point P₃ of the result data 50 illustrated in FIG. 3, sensing is performed by the radar device 2 in the direction rotated counterclockwise by θ₁ degrees (+θ₁ degrees) from the front direction of the measurement target person 100 (that is, the radar device 2 transmits a millimeter wave in the direction of +θ₁ degrees of the measurement target person 100), and as a result of the sensing, it is indicated that the reflection intensity of the millimeter wave recovered by the radar device 2 is X₂ (for example, a metal substance is detected).

According to the point P₇ of the result data 50 illustrated in FIG. 3, it is indicated that sensing is not performed by the radar device 2 in the direction rotated clockwise by θ₃ degrees (−θ₃ degrees) from the front direction of the measurement target person 100 yet (that is, it is indicated that the radar device 2 does not transmit a millimeter wave in the direction of −θ₃ degrees of the measurement target person 100 yet).

Incidentally, the points P₄ to P₆ of the result data 50 illustrated in FIG. 3 can be described in the same manner as the points P₁ to P₃ described above, and thus detailed description thereof will be omitted here. Further, in this embodiment, the result data 50 includes an angle for which sensing is required and whether or not sensing for the angle is performed, but the result data 50 may include at least information that can specify that a millimeter wave is transmitted at a predetermined angle of the measurement target person 100. For example, the result data 50 may include first information indicating that a millimeter wave is transmitted to any surface of the measurement target person 100, and the millimeter wave is not transmitted to any surface without including the information indicating the angle for which sensing is performed. In this case, the angle for which sensing is performed can be specified based on the first information described above.

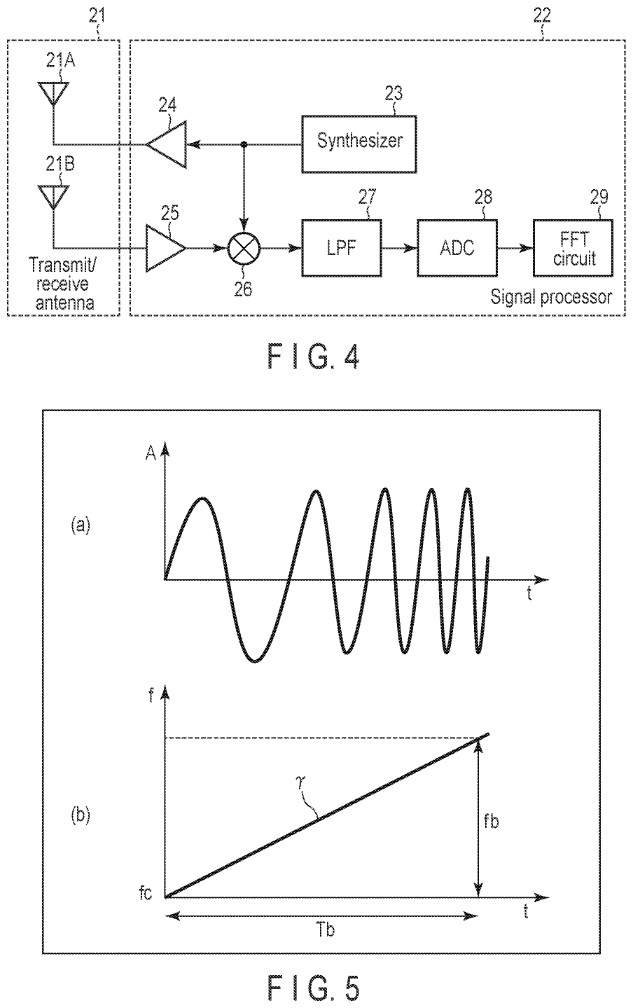

Next, a hardware configuration of the radar device 2 will be described with reference to FIG. 4.

FIG. 4 is a block diagram illustrating an example of the hardware configuration of the radar device 2. As illustrated in FIG. 4, the radar device 2 includes a transmit/receive antenna 21 and a signal processor 22. The transmit/receive antenna 21 includes one or more transmit antennas 21A and one or more receive antennas 21B. Incidentally, transmitter and receiver may be performed by one antenna without separately providing the transmit antenna 21A and receive antenna 21B.

A signal generated by a synthesizer 23 is amplified by a power amplifier (PA) 24 and then supplied to the transmit antenna 21A, and a millimeter wave is transmitted (released, radiated) from the transmit antenna 21A to the scan space. The transmitted millimeter wave is reflected by all objects present in the scan space including the measurement target person 100, and the reflected wave is received (recovered) by the receive antenna 21B. A received signal output from the receive antenna 21B is input to a first input terminal of a mixer 26 via a low noise amplifier (LNA) 25. The output signal of the synthesizer 23 is input to the second input terminal of the mixer 26.

The mixer 26 combines the transmitted signal and the received signal to generate an intermediate frequency (IF) signal. The intermediate frequency signal is input to an A/D converter (ADC) 28 via a low-pass filter (LPF) 27. The digital signal output from the A/D converter 28 is analyzed by a fast Fourier transformation (FFT) circuit 29, and the reflection intensity of the millimeter wave by the object present in the scan space is obtained. A method of obtaining the reflection intensity of the millimeter wave by the object present in the scan space will be described later.

Here, a detection principle of the radar device 2 will be described with reference to FIG. 5.

There are various combinations of transmit/receive antennas of the radar device 2. For example, there are a combination in which the reflected wave of the millimeter wave transmitted from one transmit antenna is received by multiple receive antennas, a combination in which the reflected wave of the millimeter wave transmitted from multiple transmit antennas is received by one receive antenna, and a combination in which the reflected wave of the millimeter wave transmitted from multiple transmit antennas is received by multiple receive antennas. Here, a method of obtaining the reflection intensity will be described in a combination in which the reflected wave of the millimeter wave transmitted from one transmit antenna is received by one receive antenna.

The synthesizer 23 generates a frequency modulated continuous wave (FMCW) signal of which frequency linearly increases with the lapse of time. The FMCW signal is also referred to as a chirp signal. The chirp signal is as illustrated in FIG. 5(a) when amplitude A is expressed as a function of time t, and as illustrated in FIG. 5(b) when frequency f is expressed as a function of time t. As illustrated in FIG. 5(b), the chirp signal is represented by a center frequency f_{c}, a modulation bandwidth f_{b}, and a signal time width T_{b}. The slope of the chirp signal is referred to as a frequency change rate (chirp rate) γ.

A transmitted wave Sₜ(t) of the FMCW signal radiated from the transmit antenna 26A is expressed by Equation (1).

Sₜ(t)=cos[2 n(f_{c}t+γt²/2)] (1)

The chirp rate γ is represented by Equation (2).

γ=f_{b}/T_{b} (2)

At this time, the reflected wave from a target away by a distance R from the transmit/receive antenna 26 is observed with a delay of Δt=2 R/c from a transmission timing. c is the speed of light. When the reflection intensity of the target is a, a received signal Sᵣ(t) is expressed by Equation (3).

Sᵣ(t)=a·cos[2 nf_{c}(t−Δt)+n_{γ}(t−Δt)²] (3)

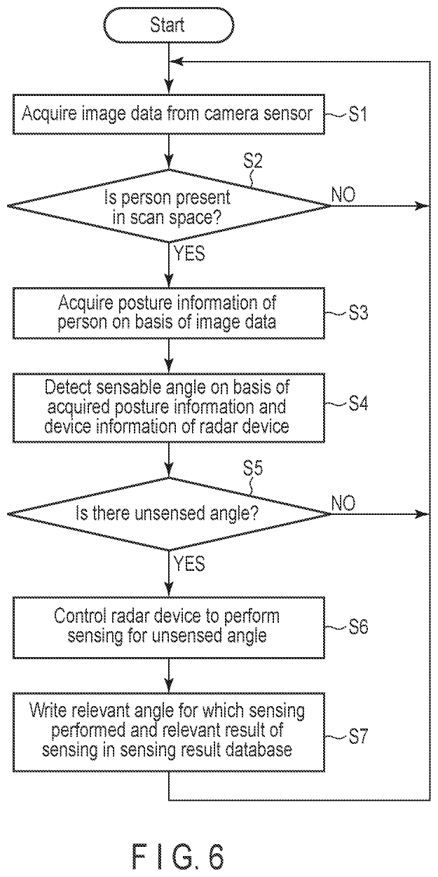

Next, an example of a procedure of a sensing process executed in the system 1 according to this embodiment will be described with reference to a flowchart of FIG. 6.

First, the posture information acquisition unit 4 acquires image data indicating an image captured by the camera sensor 3 (step S1). Incidentally, in step S1, image data indicating a plurality of images captured during a predetermined period may be acquired.

Next, the posture information acquisition unit 4 determines whether or not the person 100 is present in the scan space based on the image data acquired in step S1 (step S2). In step S2, in a case where the person 100 is included in the image indicated by the image data, it is determined that the person 100 is present in the scan space. On the other hand, in a case where the person 100 is not included in the image indicated by the image data, it is determined that the person 100 is not present in the scan space.

In a case where it is determined that the person 100 is not present in the scan space (NO in step S2), the procedure returns to step S1, and the processing is repeated.

On the other hand, in a case where it is determined that the person 100 is present in the scan space (YES in step S2), the posture information acquisition unit 4 acquires posture information of the person 100 based on the image data acquired in step S1 (step S3). The acquired posture information is sent to the controller 6.

Subsequently, the controller 6 detects the angle of the measurement target person 100 which can be sensed by the radar device 2 based on the posture information acquired in step S3 and the device information of the radar device 2 (step S4).

Next, the controller 6 collates the sensable angle detected in step S4 with the result data 50 stored in the sensing result database 5, and determines whether or not there is an angle (unsensed angle) for which sensing is not performed yet (step S5). In step S5, in a case where the detected sensable angle among the angles required to be sensed by the radar device 2 indicated by the result data 50 indicates an unsensed angle, it is determined that there is an unsensed angle. On the other hand, in a case where the detected sensable angle among the angles required to be sensed by the radar device 2 indicated by the result data 50 indicates a sensed angle, it is determined that there is no unsensed angle.

In a case where it is determined that there is no unsensed angle (NO in step S5), the procedure returns to step S1, and the processing is repeated.

On the other hand, in a case where it is determined that there is an unsensed angle (YES in step S5), the controller 6 controls the radar device 2 to perform sensing for the unsensed angle (step S6). Incidentally, in a case where there are a plurality of unsensed angles, the controller 6 selects one of the plurality of unsensed angles and then controls the radar device 2 to perform sensing for the selected angle. A method of selecting one of a plurality of unsensed angles will be described later, and thus a detailed description thereof will be omitted here.

Thereafter, the radar device 2 transmits a millimeter wave at a predetermined angle (the angle selected by the controller 6) of the measurement target person 100 according to an instruction from the controller 6. Thereafter, the radar device 2 writes the angle of the sensing performed according to the instruction from the controller 6 and the result of the sensing in the sensing result database 5 (step S7). Thereafter, the procedure returns to step S1, and similar processing is repeated again.

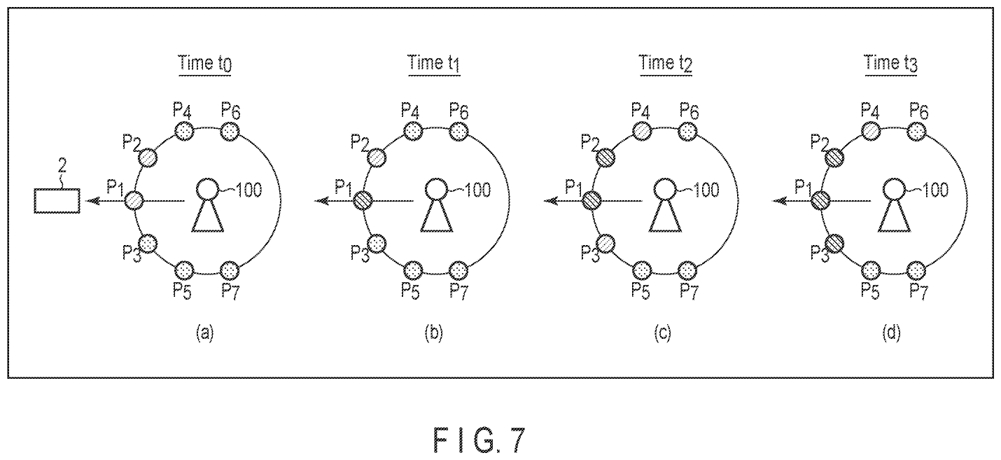

FIG. 7 illustrates an example of state transition of the sensing result database 5 in a case where the sensing process illustrated in the flowchart of FIG. 6 is repeatedly executed. Incidentally, in FIG. 7, the points corresponding to the angles for which sensing by the radar device 2 is performed are hatched in a mesh shape, the points corresponding to the angles for which sensing by the radar device 2 is not performed are hatched in a dot shape, and the points corresponding to the sensable angles of the radar device 2 are hatched with oblique lines.

In FIG. 7, it is assumed that the measurement target person 100 is moving (walking) straight and gradually approaching from a distant position toward the radar device 2, and a case is exemplified in which there is a change in the sensable angle of the radar device 2. Incidentally, although the illustration of the radar device 2 is omitted in FIGS. 7(b) to 7(d), it is assumed that the position of the radar device 2 does not change.

FIG. 7(a) illustrates the state of the sensing result database 5 before the sensing by the radar device 2 is performed (time t₀), and illustrates a case where the angle corresponding to the point P₁ and the angle corresponding to the point P₂ are detected as the sensable angles of the radar device 2 by the processing in step S4 when the sensing process illustrated in FIG. 6 is executed for the first time. Therefore, the points P₁ and P₂ in FIG. 7(a) are hatched with oblique lines as the points corresponding to the sensable angles, and the points P₃ to P₇ are hatched in a dot shape as the points corresponding to the angles for which sensing is not performed.

As illustrated in FIG. 7(a), in a case where a plurality of angles are detected as the sensable angles in a state where sensing by the radar device 2 is not performed for any angle, the controller 6 may randomly select one of the plurality of detected angles or may preferentially select an angle closest to the front direction of the measurement target person 100 from among the plurality of detected angles. Here, it is assumed that the controller 6 preferentially selects the angle closest to the front direction of the measurement target person 100, and the angle corresponding to the point P₁ is selected as the angle for sensing.

FIG. 7(b) illustrates the state of the sensing result database 5 after FIG. 7(a) (time t₁), and illustrates a case where only the angle corresponding to the point P₂ is detected as the sensable angle of the radar device 2 by the processing of step S4 when the sensing process illustrated in FIG. 6 is executed again. Therefore, the point P₂ in FIG. 7(b) is hatched with oblique lines as the point corresponding to the sensable angle. Incidentally, as described above, here, a case is assumed in which the angle corresponding to the point P₁ is selected as the angle for sensing by the controller 6 at time t₀. Thus, the point P₁ in FIG. 7(b) is hatched in a mesh shape as the point corresponding to the angle for which sensing is performed, and other points P₃ to P₇ are hatched in a dot shape as the points corresponding to the angles for which sensing is not performed.

As illustrated in FIG. 7(b), in a case where only one angle is detected as the sensable angle, the controller 6 selects the one angle as the angle for sensing. Therefore, the angle corresponding to the point P₂ is selected as the angle for sensing by the controller 6.

FIG. 7(c) illustrates the state of the sensing result database 5 after FIG. 7(b) (time t₂), and illustrates a case where the angle corresponding to the point P₃ and the angle corresponding to the point P₄ are detected as the sensable angles by the radar device 2 by the processing in step S4 when the sensing process illustrated in FIG. 6 is executed again. Therefore, the points P₃ and P₄ in FIG. 7(c) are hatched with oblique lines as the points corresponding to the sensable angles. Incidentally, as described above, here, it is assumed that the angle corresponding to the point P₁ is selected as the angle for sensing by the controller 6 at time t₀, and the angle corresponding to the point P₂ is selected as the angle for sensing by the controller 6 at time t₁. Thus, the points P₁ and P₂ in FIG. 7(c) are hatched in a mesh shape as the points corresponding to the angles for which sensing is performed, and other points P₅ to P₇ are hatched in a dot shape as the points corresponding to the angles for which sensing is not performed.

As illustrated in FIG. 7(c), in a case where a plurality of angles are detected as the sensable angles in a state where sensing by the radar device 2 is already performed, the controller 6 may randomly select one of the plurality of detected angles, may preferentially select an angle closest to the front direction of the measurement target person 100 from among the plurality of detected angles, or may preferentially select an angle farthest from the already sensed angle among the plurality of detected angles. Here, a case is assumed in which the controller 6 preferentially selects the angle closest to the front direction of the measurement target person 100, and the angle corresponding to the point P₃ is selected as the angle for sensing.

FIG. 7(d) illustrates the state of the sensing result database 5 after FIG. 7(c) (time t₃), and illustrates a case where only the angle corresponding to the point P₄ is detected as the sensable angle of the radar device 2 by the processing of step S4 when the sensing process illustrated in FIG. 6 is executed again. Therefore, the point P₄ in FIG. 7(d) is hatched with oblique lines as the point corresponding to the sensable angle. Incidentally, as described above, it is assumed that the angle corresponding to the point P₁ is selected as the angle for sensing by the controller 6 at time t₀, the angle corresponding to the point P₂ is selected as the angle for sensing by the controller 6 at time t₁, and the angle corresponding to the point P₃ is selected as the angle for sensing by the controller 6 at time t₂. Thus, the points P₁ to P₃ in FIG. 7(d) are hatched in a mesh shape as the points corresponding to the angles for which sensing is performed, and other points P₅ to P₇ are hatched in a dot shape as the points corresponding to the angles for which sensing is not performed.

As illustrated in FIG. 7(d), in a case where only one angle is detected as the sensable angle, the controller 6 selects the one angle as the angle for sensing. Thus, the angle corresponding to the point P₄ is selected as the angle for sensing by the controller 6.

As described above, by repeatedly executing the sensing process illustrated in FIG. 6, the sensing result database 5 transitions in state as illustrated in FIGS. 7(a) to 7(d). It is preferable that the sensing process illustrated in FIG. 6 is further repeatedly executed, and sensing by the radar device 2 is also performed for the angles corresponding to the points P₅ to P₇ for which sensing is not yet performed at time t₃, and it is possible to suppress the miss detection of the metal substance as the angle for which sensing is performed increases.

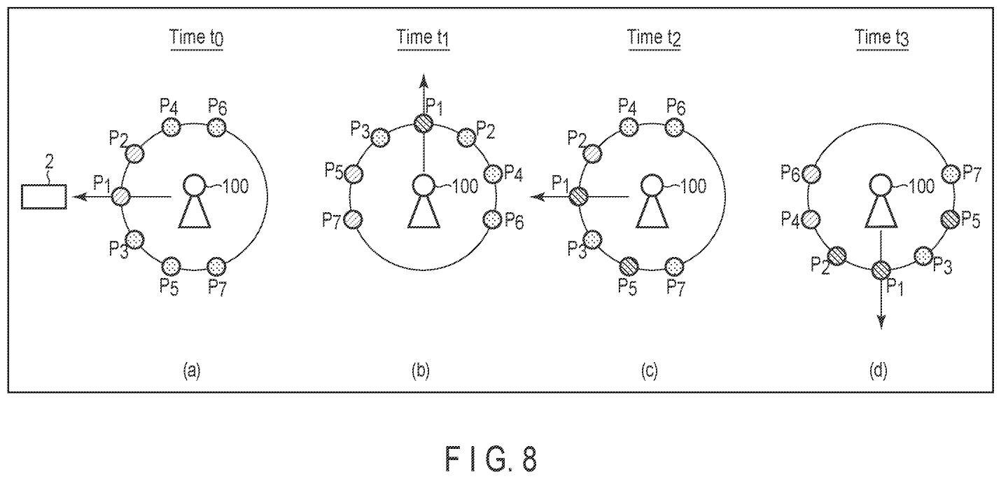

FIG. 8 is an example of state transition of the sensing result database 5 in a case where the sensing process illustrated in the flowchart of FIG. 6 is repeatedly executed, and illustrates an example different from that of FIG. 7. Incidentally, in FIG. 8, similarly to FIG. 7, the points corresponding to the angles for which sensing by the radar device 2 is performed are hatched in a mesh shape, the points corresponding to the angles for which sensing by the radar device 2 is not performed are hatched in a dot shape, and the points corresponding to the sensable angles of the radar device 2 are hatched with oblique lines.

In FIG. 8, it is assumed that the measurement target person 100 is moving (walking) while changing the direction as appropriate, and a case is exemplified in which there is a change in the sensable angle of the radar device 2. Incidentally, although the illustration of the radar device 2 is omitted in FIGS. 8(b) to 8(d), it is assumed that the position of the radar device 2 does not change.

FIG. 8(a) illustrates the state of the sensing result database 5 before the sensing by the radar device 2 is performed (time t₀), and illustrates a case where the angle corresponding to the point P₁ and the angle corresponding to the point P₂ are detected as the sensable angles of the radar device 2 by the processing in step S4 when the sensing process illustrated in FIG. 6 is executed for the first time. Therefore, the points P₁ and P₂ in FIG. 8(a) are hatched with oblique lines as the points corresponding to the sensable angles, and the points P₃ to P₇ are hatched in a dot shape as the points corresponding to the angles for which sensing is not performed.

In this case, as in the case of FIG. 7(a), the controller 6 may randomly select one of the plurality of detected angles, or may preferentially select an angle closest to the front direction of the measurement target person 100 from among the plurality of detected angles. Here, it is assumed that the controller 6 preferentially selects the angle closest to the front direction of the measurement target person 100, and the angle corresponding to the point P₁ is selected as the angle for sensing.

FIG. 8(b) illustrates the state of the sensing result database 5 after FIG. 8(a) (time t₁), and illustrates a case where the angle corresponding to the point P₅ and the angle corresponding to the point P₇ are detected as the sensable angles by the radar device 2 by the processing in step S4 when the sensing process illustrated in FIG. 6 is executed again. Incidentally, at time t₁, as illustrated in FIG. 8(b), the measurement target person 100 faces a left direction as viewed from the radar device 2. In other words, the radar device 2 is positioned in the left direction with the front direction of the measurement target person 100 as a reference. The points P₅ and P₇ in FIG. 8(b) are hatched with oblique lines as the points corresponding to the sensable angles. Incidentally, as described above, here, a case is assumed in which the angle corresponding to the point P₁ is selected as the angle for sensing by the controller 6 at time t₀. Thus, the point P₁ in FIG. 8(b) is hatched in a mesh shape as the point corresponding to the angle for which sensing is performed, and other points P₂ to P₄ and P₆ are hatched in a dot shape as the points corresponding to the angles for which sensing is not performed.

In this case, as in the case of FIG. 7(c), the controller 6 may randomly select one of the plurality of detected angles, may preferentially select an angle closest to the front direction of the measurement target person 100 from among the plurality of detected angles, or may preferentially select an angle farthest from the already sensed angle among the plurality of detected angles. Here, a case is assumed in which the controller 6 preferentially selects the angle closest to the front direction of the measurement target person 100, and the angle corresponding to the point P₅ is selected as the angle for sensing.

FIG. 8(c) illustrates the state of the sensing result database 5 after FIG. 8(b) (time t₂), and illustrates a case where only the angle corresponding to the point P₂ is detected as the sensable angle of the radar device 2 by the processing of step S4 when the sensing process illustrated in FIG. 6 is executed again. Incidentally, at time t₂, as illustrated in FIG. 8(c), the measurement target person 100 faces the radar device 2. In other words, the radar device 2 is positioned in the front direction of the measurement target person 100. The point P₂ in FIG. 8(c) is hatched with oblique lines as the point corresponding to the sensable angle. Incidentally, as described above, here, it is assumed that the angle corresponding to the point P₁ is selected as the angle for sensing by the controller 6 at time t₀, and the angle corresponding to the point P₅ is selected as the angle for sensing at time t₁. Thus, the points P₁ and P₅ in FIG. 8(c) are hatched in a mesh shape as the points corresponding to the angles for which sensing is performed, and other points P₃, P₄, P₆, and P₇ are hatched in a dot shape as the points corresponding to the angles for which sensing is not performed.

In this case, as in the case of FIG. 7(b), the controller 6 selects one detected angle as the angle for sensing. Therefore, the angle corresponding to the point P₂ is selected as the angle for sensing by the controller 6.

FIG. 8(d) illustrates the state of the sensing result database 5 after FIG. 8(c) (time t₃), and assumes a case where the angles corresponding to the points P₄ and P₆ are detected as the sensable angle of the radar device 2 by the processing of step S4 when the sensing process illustrated in FIG. 6 is executed again. Incidentally, at time t₃, as illustrated in FIG. 8(d), the measurement target person 100 faces a right direction as viewed from the radar device 2. In other words, the radar device 2 is positioned in the right direction with the front direction of the measurement target person 100 as a reference. The points P₄ and P₆ in FIG. 8(d) are hatched with oblique lines as the points corresponding to the sensable angles. Incidentally, as described above, here, it is assumed that the angle corresponding to the point Pₗ is selected as the angle for sensing by the controller 6 at time t₀, the angle corresponding to the point P₅ is selected as the angle for sensing at time t₁, and the angle corresponding to the point P₂ is selected as the angle for sensing at time t₂. Thus, the points P₁, P₂, and P₅ in FIG. 8(d) are hatched in a mesh shape as the points corresponding to the angles for which sensing is performed, and other points P₃ and P₇ are hatched in a dot shape as the points corresponding to the angles for which sensing is not performed.

In this case, as in the case of FIG. 8(b), the controller 6 may randomly select one of the plurality of detected angles, may preferentially select an angle closest to the front direction of the measurement target person 100 from among the plurality of detected angles, or may preferentially select an angle farthest from the already sensed angle among the plurality of detected angles. Here, a case is assumed in which the controller 6 preferentially selects the angle closest to the front direction of the measurement target person 100, and the angle corresponding to the point P₄ is selected as the angle for sensing.

As described above, by repeatedly executing the sensing process illustrated in FIG. 6, the sensing result database 5 transitions in state as illustrated in FIGS. 8(a) to 8(d). It is preferable that the sensing process illustrated in FIG. 6 is further repeatedly executed, and the sensing by the radar device 2 is also performed for the angles corresponding to the points P₃, P₆, and P₇ for which sensing is not yet performed at time t₃, and it is possible to suppress the miss detection of the metal substance as the angle for which sensing is performed increases.

In the first embodiment described above, the controller 6 detects the angle of the measurement target which is sensable by the radar device 2. The controller 6 collates the detected sensable angle with the result data 50 (past data) stored in the sensing result database 5, and controls the radar device 2 to perform sensing for the detected sensable angle in a case where sensing for the detected sensable angle is not yet performed. In the case of performing sensing, the radar device 2 writes an angle for performing sensing and a result of the sensing in the sensing result database 5, and feeds back the angle and the result as past data. By repeatedly executing the sensing process as described above, the angle for which the sensing by the radar device 2 is not performed can be gradually reduced, and as a result, the system 1 can suppress the miss detection of the metal substance.

Incidentally, in a case where the reflection intensity received by the radar device 2 exceeds a predetermined threshold as a result of sensing by the radar device 2, the system 1 according to this embodiment detects that the measurement target person 100 possesses a metal substance (detects that the measurement target is a metal substance). Although not illustrated in FIG. 2, the system 1 according to this embodiment may further include an alarm issuing unit which issues an alarm in a case where the reflection intensity received by the radar device 2 exceeds the predetermined threshold.

Incidentally, in the system 1 according to this embodiment, the result of sensing by the radar device 2 may be a scan image instead of the reflection intensity of the millimeter wave. In this case, the system 1 uses an image recognition algorithm to detect whether or not a scan image obtained as a result of sensing by the radar device 2 is a metallic dangerous article (a gun or a knife) and to detect whether or not the measurement target person 100 possesses the metallic dangerous article.

Further, in the system 1 according to this embodiment, the controller 6 controls the radar device 2. However, in a case where the radar device 2 is installed at the tip or the like of the robot arm as described above, the controller 6 may control the operation of the robot arm and indirectly control the radar device 2.

### Second Embodiment

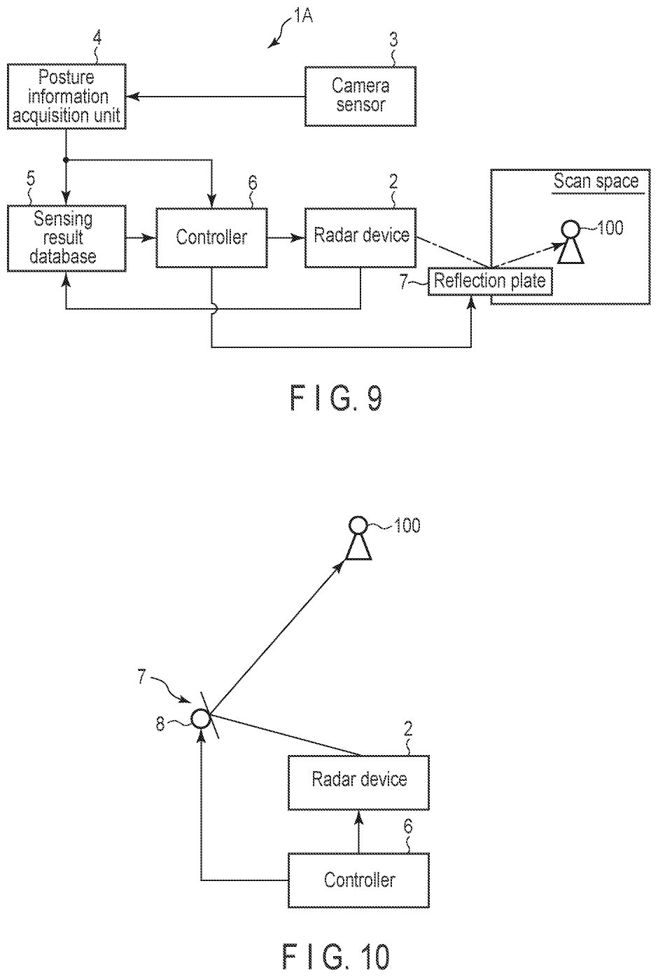

Next, a second embodiment will be described. FIG. 9 is a block diagram illustrating an example of a functional configuration of a system 1A according to the second embodiment. As illustrated in FIG. 9, the system 1A according to the second embodiment is different from the system 1 according to the first embodiment described above in that the system 1A further includes a reflection plate 7. Hereinafter, only portions different from those of the first embodiment described above will be described, and description of portions common to those of the first embodiment described above will be omitted.

The reflection plate 7 is provided in the scan space. The reflection plate 7 reflects the millimeter wave transmitted from a radar device 2 toward a measurement target person 100. The reflection plate 7 may be any plate as long as it reflects the millimeter wave transmitted from the radar device 2, but in consideration of reflection characteristics and the like, it is preferable that the reflection plate 7 is formed of metal.

Incidentally, in order to transmit millimeter waves to various angles of the measurement target person 100, it is preferable that the reflection plate 7 includes an adjustment mechanism 8 capable of adjusting the inclination angle of a reflection surface as illustrated in FIG. 10. The adjustment mechanism 8 is communicably connected to a controller 6, for example, and adjusts the inclination angle of the reflection surface of the reflection plate 7 according to an instruction from the controller 6.

The optimum inclination angle (in other words, a condition that a millimeter wave can be transmitted to a measurement target to the maximum via the reflection plate 7) of the reflection surface of the reflection plate 7 is geometrically calculated (determined) by the controller 6 based on the position of the measurement target (person 100) with respect to the radar device 2 and the position of the reflection plate 7 with respect to the radar device 2.

According to the second embodiment described above, by utilizing reflection by the reflection plate 7, it is possible to transmit millimeter waves to various angles of the measurement target without moving the radar device 2 itself by a robot arm or the like.

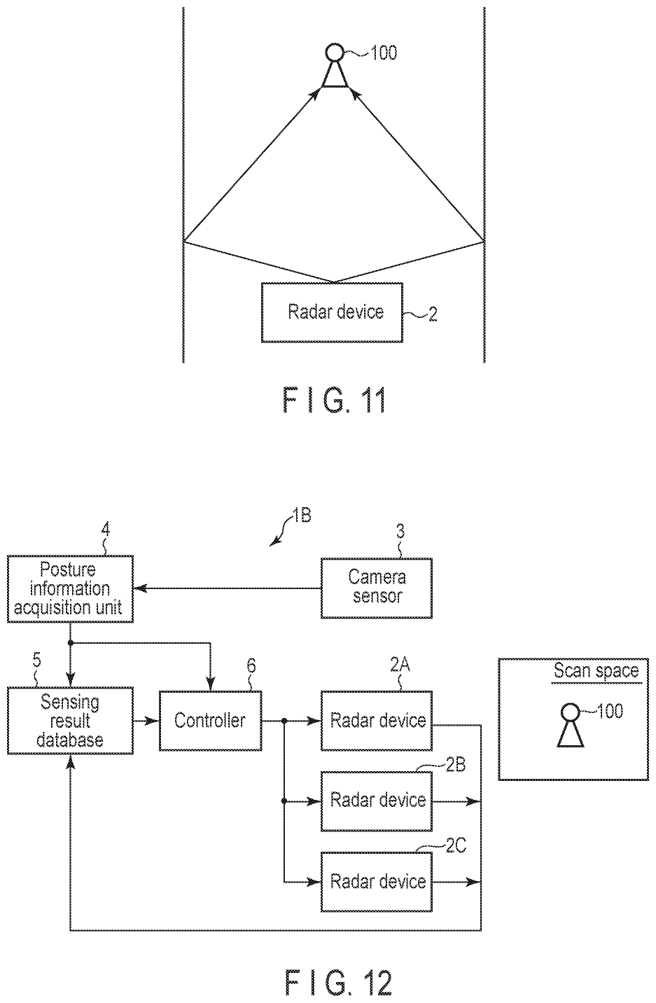

Incidentally, in FIGS. 9 and 10, the reflection plate 7 is provided in the scan space to enable the transmission of millimeter waves to the measurement target using reflection, but a method of transmitting millimeter waves to the measurement target using reflection is not limited thereto. For example, as illustrated in FIG. 11, the millimeter wave transmitted from the radar device 2 may be reflected toward the measurement target person 100 by using a wall or the like positioned in the scan space.

In this case, the wall positioned in the scan space cannot adjust the inclination angle of the reflection surface unlike the reflection plate 7 described above. Thus, the controller 6 detects (calculates) the position of the wall to which a millimeter wave is transmitted (collide) to irradiate the measurement target with the millimeter wave to the maximum and controls the radar device 2 such that the millimeter wave is transmitted to the calculated position.

According to this, even when the reflection plate 7 is not provided, it is possible to obtain an effect similar to the above-described effect by using reflection by a wall or the like.

### Third Embodiment

Further, a third embodiment will be described. FIG. 12 is a block diagram illustrating an example of a functional configuration of a system 1B according to the third embodiment. As illustrated in FIG. 12, the system 1B according to the third embodiment is different from the system 1 according to the first embodiment described above in that the system 1B includes a plurality of radar devices 2A to 2C. Hereinafter, only portions different from those of the first embodiment described above will be described, and description of portions common to those of the first embodiment described above will be omitted.

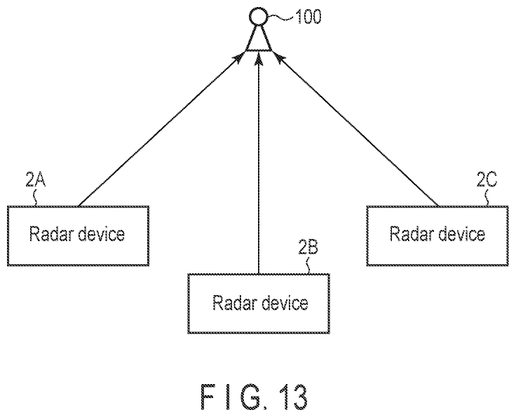

As illustrated in FIG. 13, the plurality of radar devices 2A to 2C are installed at respective positions where millimeter waves can be transmitted with respect to different angles of a measurement target person 100. The operations of the plurality of radar devices 2A to 2C are synchronized by the controller 6. The controller 6 may detect (determine) the angle of sensing performed by each of the radar devices 2A to 2C by executing the sensing process illustrated in FIG. 6 for each of the radar devices 2A to 2C, or may execute the sensing process illustrated in FIG. 6 for one of the plurality of radar devices 2A to 2C to detect the angle of sensing performed by the one radar device 2 and then detect the angles of sensing performed by the other radar device 2 according to the installation positions of the other radar devices 2.

Incidentally, among the plurality of radar devices 2A to 2C, the controller 6 performs control to transmit a millimeter wave only for the radar device 2 which can perform sensing for an unsensed angle, and performs control not to transmit a millimeter wave for the radar device 2 which cannot perform sensing for an unsensed angle. According to this, only the radar device 2 necessary for suppressing the miss detection of the metal substance among the plurality of radar devices 2A to 2C can be operated. Thus, redundant sensing results can be reduced, and the signal processing amount in the system 1B can be reduced.

According to the third embodiment described above, a plurality of radar devices 2 is installed, and thus it is possible to transmit millimeter waves to various angles of the measurement target without moving one radar device 2 by a robot arm or the like. Further, when a plurality of radar devices 2 is installed, sensing can be performed by the plurality of radar devices 2 even when a large number of objects are present in the scan space. Thus, it is possible to minimize the influence due to the presence of a large number of objects in the scan space and to suppress a decrease in detection accuracy.

According to at least one embodiment described above, it is possible to provide a system and a method capable of suppressing the miss detection which may occur in a system which detects an object by using radio waves.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A system comprising:
a radar device configured to transmit a first radio wave to an object in a direction of a first angle of the object;
a storage device configured to store first information capable of specifying that a radio wave is transmitted to the first angle of the object by the radar device; and
a controller configured to control a direction of a second radio wave to be transmitted by the radar device after the transmission of the first radio wave to a second angle of the object different from the first angle.

2. The system of claim 1, wherein
the first angle is an angle specified, with a specific direction of the object as a reference, by a difference between the specific direction and a direction in which a radio wave is transmitted, and
the second angle is an angle specified by a difference between the specific direction of the object and a direction in which a radio wave is to be transmitted with the specific direction of the object as a reference.

3. The system of claim 1, further comprising:
a camera sensor configured to detect the object; and
a detector configured to detect the direction of the object based on a detection result by the camera sensor, wherein
the controller
detects an angle of the object to which the radar device is capable of transmitting a radio wave based on the direction of the object detected by the detector.

4. The system of claim 3, wherein
the detector
further detects a position of the object based on the detection result by the camera sensor, and
the controller
detects the angle of the object to which the radar device is capable of transmitting a radio wave based on the direction of the object and the position of the object detected by the detector.

5. The system of claim 4, further comprising:
a reflection plate configured to reflect a radio wave transmitted from the radar device toward the object and radiates the radio wave in a direction of a predetermined angle of the object.

6. The system of claim 5, further comprising:
an adjustment mechanism capable of adjusting an inclination angle of the reflection plate, wherein
the controller
determines the inclination angle based on a position of the object with respect to the radar device and a position of the reflection plate with respect to the radar device, and
controls the adjustment mechanism to obtain the determined inclination angle.

7. The system of claim 1, wherein
a plurality of the radar devices are provided, and
the radar devices are installed at positions where the radar devices can transmit radio waves to different angles of the object.

8. The system of claim 7, wherein
the controller
controls a radar device capable of transmitting a radio wave in a direction of the second angle of the object among the radar devices to transmit the second radio wave, and
controls a radar device incapable of transmitting a radio wave in the direction of the second angle of the object among the radar devices not to transmit the second radio wave.

9. The system of claim 1, wherein
the radar device is installed at a robot arm which is movable around the object, and
the controller
controls the direction of the second radio wave transmitted by the radar device to the second angle of the object by controlling an operation of the robot arm.

10. The system of claim 1, wherein
the storage device
stores a plurality of preferable angles of the target object for transmitting a radio wave in advance, and
the controller
controls the radar device such that the first information is stored for the angles stored in advance in the storage device.

11. The system of claim 1, wherein
the radar device
detects that the object is a metal substance in a case where a reflection intensity of a radio wave transmitted to the object exceeds a threshold.

12. The system of claim 11, further comprising:
an alarm issuing unit that issues an alarm in a case where the radar device detects that the object is a metal substance.

13. A method executed by a system including a radar device, the method comprising:
transmitting a first radio wave to an object in a direction of a first angle of the object;
storing, in a storage device, first information capable of specifying that a radio wave is transmitted to the first angle of the object by the radar device; and
controlling a direction of a second radio wave transmitted by the radar device after the transmission of the first radio wave to a second angle of the object different from the first angle.

14. A system communicably connected to a radar device capable of transmitting a first radio wave to an object in a direction of a first angle of the object, the system comprising:
a storage device configured to store first information capable of specifying that a radio wave is transmitted to the first angle of the object by the radar device; and
a transmitter configured to transmit a signal for controlling a direction of a second radio wave transmitted by the radar device after the transmission of the first radio wave to a second angle of the object different from the first angle.
